(19) United States
(12) Patent Application Publication
(10) Pub. No.: US 2017/0374300 A1
(43) Pub. Date: Dec. 28, 2017

(54) Night Vision System for Vehicles

(71) Applicant: Pedro Gimena, West Roxbury, MA (US)

(72) Inventor: Pedro Gimena, West Roxbury, MA (US)

(21) Appl. No.: 15/632,418

(22) Filed: Jun. 26, 2017

Related U.S. Application Data
(60) Provisional application No. 62/354,333, filed on Jun. 24, 2016.

(51) Int. Cl. H04N 5/33; B60J 1/00; G02B 5/28; G02B 23/12

(52) U.S. Cl. CPC H04N 5/332; G02B 23/12; B60J 1/003; G02B 5/285

(57) ABSTRACT

A vehicle vision system, disposed for use in either non-convertibles or convertibles vehicles, and for use in either hardtop or soft top systems. The system includes window panels that convert from day vision to night vision system mechanism and the system may include one window panel or two window panels. The rear window (day vision) will depress to a back compartment and the night vision window will elevate to replace the day window. In an additional embodiment, the night depress to a front compartment and the night vision window will elevate to replace the night window. This will also be performed vice versa for both the front and rear window. Side mirrors will also convert at the same time the window panels convert from day light to night light system mechanism, and vice versa.

### CROSS REFERENCE TO RELATED APPLICATION

This application claims the benefit of and takes priority from U.S. Provisional Patent Application Ser. No. 62/354,333 filed on Jun. 24, 2016, the contents of which are herein incorporated by reference.

### BACKGROUND OF THE INVENTION

### Field of the Invention

The subject invention relates to a system, and series of mechanisms for converting normal daytime vision, more particularly a vehicle with day light and night vision mechanism, wherein the driver(s) will be able to see when traveling through dark areas.

### Description of the Related Art

Night vision devices, are used to strengthen human vision under very low light conditions. There are several types of night vision scopes. Infrared imaging systems, also referred to as “active” night vision devices, focus infrared light on a scene. Infrared is beyond the light spectrum visible to humans, so the beam itself is undetectable. Image-converting technology transforms the scene illuminated by the infrared into a visible image. Thermal imaging systems work in a similar way, converting the pattern of heat emitted by objects, people, or animals into a visual image.

There are also “passive” night vision systems. These systems amplify images picked up in minimal light, such as starlight, into visible images. The view through a passive night vision device may be from 20,000 to 50,000 times brighter than what the unaided eye could see.

A convertible is an automobile body style that can convert between an open-air mode and an enclosed one, varying in degree and means by model. A hardtop is a rigid form of automobile roof. They may be detachable for separate storing, retractable within the vehicle itself, or permanently attached to an auto lacking a center side-support known as a B-pillar. The term is also used to describe such vehicles, principally the last.

Car glass includes windscreens, side and rear windows, and glass panel roofs on a vehicle. Side windows can be either fixed or be raised and lowered by pressing a button (power window) or switch or using a hand-turned crank.

Power windows or electric windows are automobile windows which can be raised and lowered by depressing a button or switch, as opposed to using a hand-turned crank handle. Power assists originated in the need and desire to move convertible body-style tops up and down by some means other than human effort.

Some vehicles include sun blinds for rear and rear side windows. The window shield of a car is appropriate for safety and protection of debris in the road. It also comforts the driver as well. The majority of car glass is held in place by glass run channels, which also serve to contain any fragments of glass if the glass breaks. Today most cars use laminated glass as it does not shatter in sharp pieces and so does not harm the driver and passengers.

### SUMMARY OF THE INVENTION

The system, method and series of apparatuses, as illustrated herein, is clearly not anticipated, rendered obvious, or even present in any of the prior art mechanisms, either alone or in any combination thereof. The versatile system, method and series of apparatuses for creating and utilizing a system for night vision for vehicles are all illustrated. Thus, the several embodiments of the mechanism are illustrated herein.

It is therefore an object of the present invention to provide a new system mechanism for drivers to see more clearly in dark areas and during late-night hours.

It is a further object of the present invention to provide a new system mechanism for vehicle power windows to feature day light and night vision. Each window has two window panels: one for night vision and one for day vision. The rear window (day vision) will depress to a back compartment and the night vision window will elevate to replace the day window. Additionally, the front window (day vision) will depress to a front compartment and the night vision window will elevate to replace the night window. This will also be performed vice versa for both the front and rear window.

The invention results from the realization that a convertible or hardtop vehicle's power window system will be revolutionized by a day vision night vision system mechanism. In this way, a driver may have better clarity when driving at night through dark areas. This will have the same window panels, however, during the day it will be roofless.

It is yet another object of the present invention to provide a system mechanism for law enforcement to use day and night vision windows in their vehicles during investigative work of criminals.

In one embodiment, an alternative vehicle vision system wherein a driver can adjust window panels between day light and night light, is shown, wherein the system includes a vehicle chassis, at least one set of window panels for day usage and at least one set of window panels for night usage.

Additionally, in this embodiment, the alternative vehicle vision system includes at least one set of window panels for day usage comprise a retractable construction and the at least one set of window panels for night usage comprise a retractable construction.

Furthermore, the vehicle chassis comprises at least two door members wherein the at least one set of window panels for day usage is disposed within the at least two door members; and wherein the at least one set of window panels for night usage is disposed within the at least two door members.

In yet another embodiment, upon implementation of the alternative vehicle vision system, the at least one set of window panels for day usage is retracted and the at least one set of window panels for night usage is extended. Also the system includes front and rear night vision members.

In yet another embodiment, the alternative vehicle vision system comprises at least one day window panel and at least one night window panel wherein the at least one day window panel and at least one night window panel are in mechanical communication and act as a sequence of one element.

Another object of the invention is to present an alternative vehicle vision system wherein the window panels of a vehicle that is roofless during the day converts to night vision and wherein the vehicle has either single or double window panels.

It is yet another object to present an alternative vehicle vision system comprising a soft top convertible comprising a set of window panels wherein the each individual in the set of window panels of the soft top convertible comprise a set of two window panels.

In yet another alternate embodiment, the alternative vehicle vision includes at least one set of window panels for night usage is made of a polymeric material that folds and extends when the soft top covers the car during the night.

Additionally, the alternative vehicle vision system includes at least one set of window panels for night usage uses the blending and mixing of low light imagery systems, thermal imaging and infrared illumination. The system allows for the day vision would convert to night vision by activating a button.

There has thus been outlined, rather broadly, the more important features of the embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein and these aspects are indicative of the various ways in which the principles disclosed herein may be practiced and all aspects and equivalents thereof are intended to be within the scope of the claimed subject matter.

### BRIEF DESCRIPTION OF THE DRAWINGS

FIGS. 1A and 1B illustrates a convertible automobile with a hard top and a soft top respectively;

FIG. 2 illustrates an elevation view of a set of window panels for use in an alternative vehicle vision system in a convertible automobile;

FIG. 3A illustrates one embodiment of the alternative vehicle vision system for use in a hardtop convertible automobile;

FIG. 3B illustrates an elevation view of a set of window panels in the alternative vehicle vision system for use in a two door hard top convertible automobile;

FIG. 3C illustrates an elevation view of a set of window panels in the alternative vehicle vision system for use in a four door hard top convertible automobile;

FIG. 4A illustrates a convertible automobile with a soft top roof;

FIG. 4B illustrates an elevation view of a set of window panels in the alternative vehicle vision system for use in a two door soft top convertible automobile;

FIG. 5 illustrates a perspective view of a side mirror for a convertible automobile;

FIG. 6 illustrates one embodiment of the alternative vehicle vision system for automobile windows;

FIG. 7 illustrates yet another embodiment of an elevation view of the alternative vehicle vision system for use in a two door soft top convertible automobile.

### DETAILED DESCRIPTION OF THE SEVERAL EMBODIMENTS

The detailed description set forth below is intended as a description of presently preferred embodiments of the invention and does not represent the only forms in which the present invention may be construed and/or utilized. The description sets forth the functions and the sequence of the steps for producing the invention. However, it is to be understood that the same or equivalent functions and sequences may be accomplished by different embodiments also intended to be encompassed within the scope of the invention.

The present invention will be described in terms of a system mechanism, specifically for power windows that can convert from day vision to night vision. In order to execute this proposed system mechanism, night vision is needed as well as a hard or soft top convertible. This system mechanism is specifically for convertibles. The convertible can either be a hard top or a soft top, as each the proposed mechanism will be effective for either roof type.

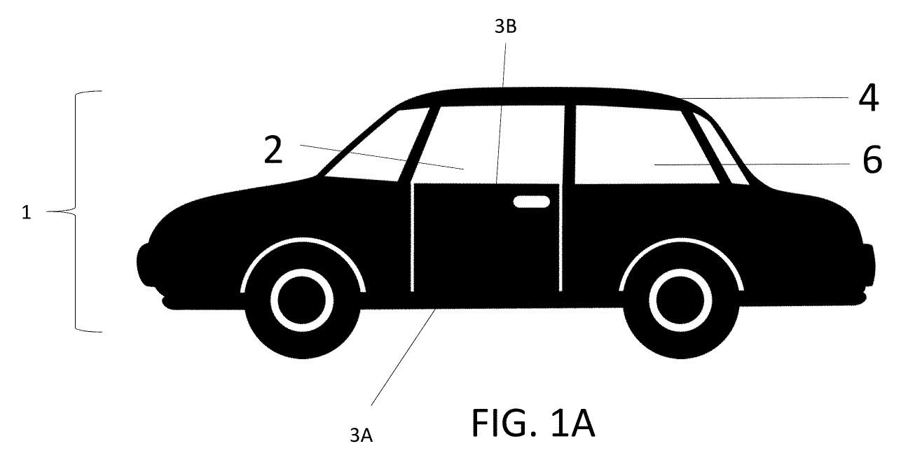

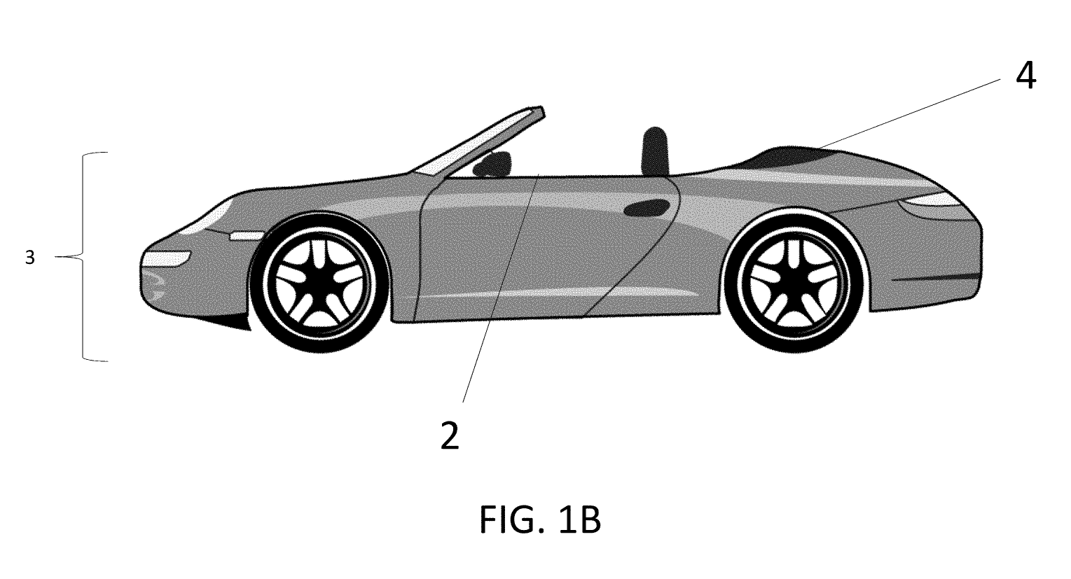

Referring to FIGS. 1A-1B, an automobile 1 and a convertible automobile 3 are illustrated respectively. In a standard automobile 1 as shown in FIG. 1A, the automobile 1 will include a set of front window panels 2 and a set of rear window panels 6. In one embodiment, the set of front window panels 2 and the set of rear window panels 6 will be on both the driver side and passenger side of the automobile 1. Additionally, a roof 4 located on the automobile may be either a hard top or a soft top depending on the type of convertible automobile 3. Additionally, in this embodiment, at least two door members 3A and 3B are located on the automobile 1, preferably a driver's side door member 3A and a passenger's side door member 3B.

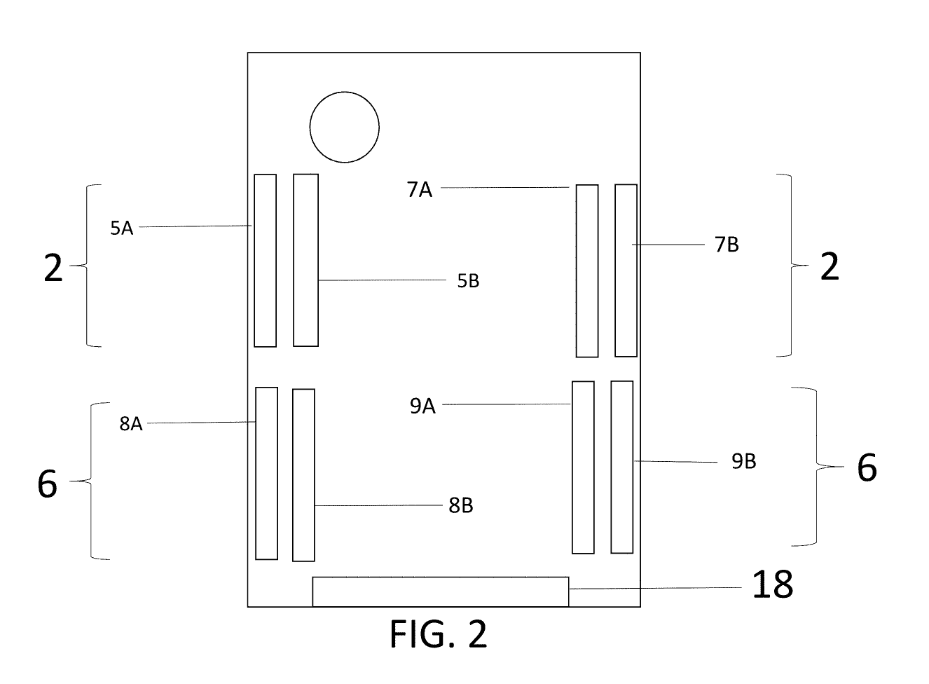

FIG. 2 illustrates an elevation view of an automobile with a set of front window panels 2 (one located on the driver's side of the automobile and one located on the passenger's side of the automobile) which includes a set of day usage front window panels 5A and 7B and a set of night usage front window panels 5B and 7A. Furthermore, a set of rear window panels 6 (one located on the driver's side of the automobile and one located on the passenger's side of the automobile) include a set of day usage rear window panels 8A and 9B and a set of night usage rear window panels 8B and 9A. Additionally, in this embodiment, a rear window 18 is shown, wherein the rear window 18 (day vision) will depress to a back compartment and a night vision window will elevate to replace the day window. Additionally, in use, the set of day usage front window panels 5A and 7B and the set of day usage rear window panels 8A and 9B will depress to a front compartment and the night usage front window panels 5B and 7A and the set of night usage rear window panels 8B and 9A will elevate to replace the day window. This will also be performed vice versa for night windows to day vision windows.

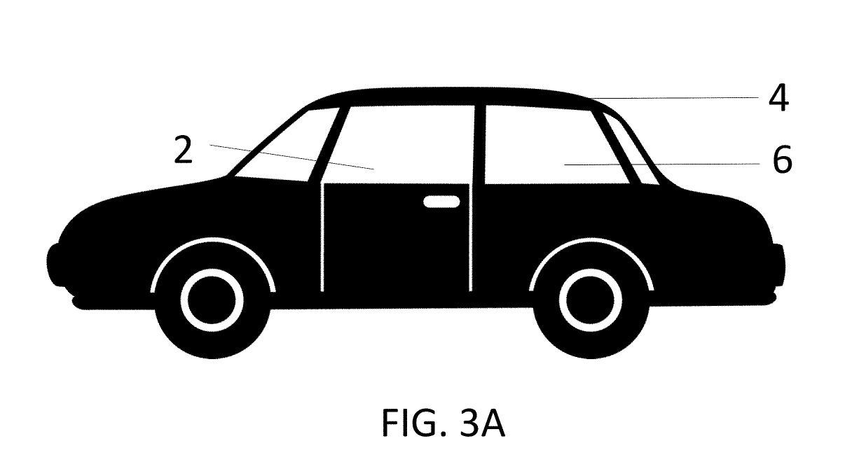

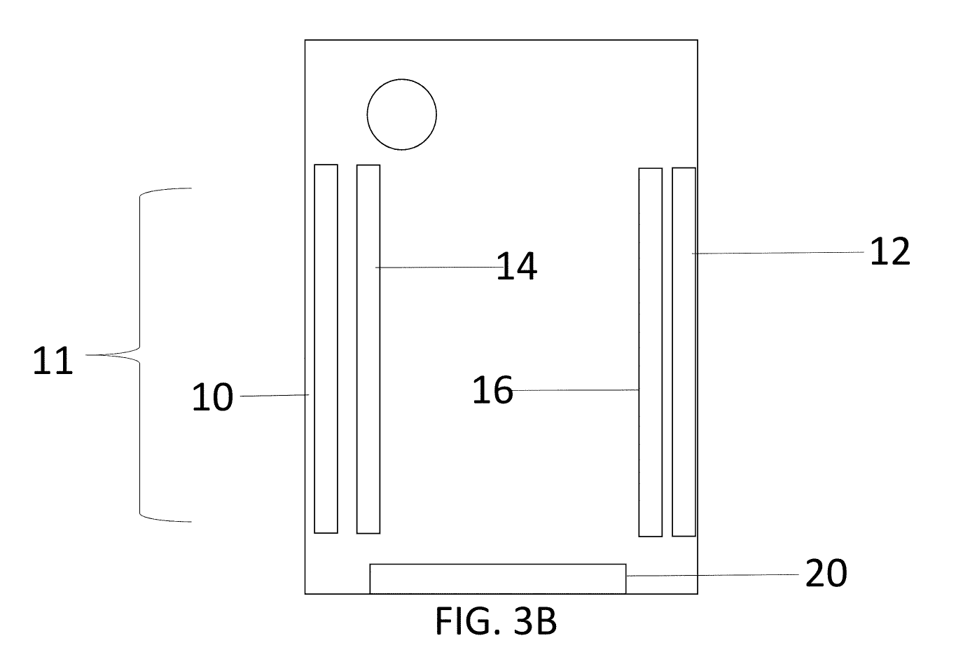

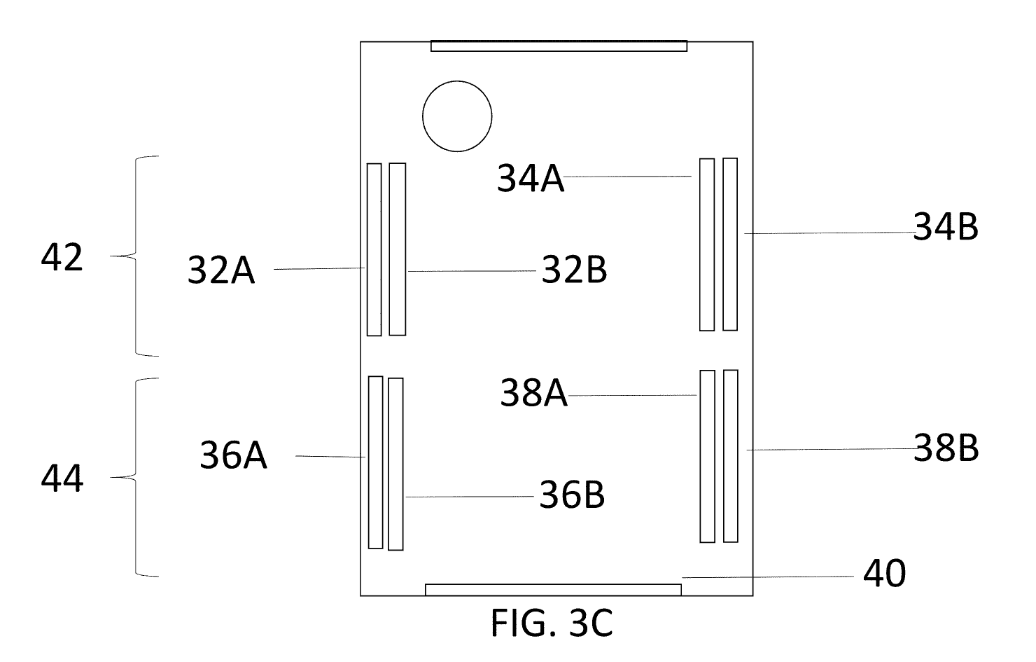

FIGS. 3A-3C illustrate one embodiment of the alternative vehicle vision system, wherein the automobile 1 is a convertible automobile with a hard top roof 4. In one embodiment, the proposed mechanism is the same as shown in FIG. 2 with the exception that there is only one set of window panels on the driver's side and the passenger's side. During the day, it is likely that the vehicle would be in use without the hard top roof 4 (see FIG. 1B). As such, this embodiment of the proposed mechanism may be for either single or double window panels. Specifically, FIG. 3B, there would be a set of window panels for day usage 10, 12 and a set of window panels for night usage 14, 16.

FIG. 3B illustrates an embodiment of the alternative vehicle vision system wherein the convertible automobile includes one set of window panels 11, and wherein the set of windows panels includes one ‘day’ window 10 and one ‘night’ window 14 on the driver's side and one day window 12 and one ‘night’ window on the passenger side 16.

Separately, in FIG. 3C, in this embodiment a set of front window panels 42 and a set of rear window panels 44 are shown. In this embodiment with the two sets of window panels, the proposed mechanism will be the same as described in FIG. 2. The set of front window panels 42 (one located on the driver's side of the automobile and one located on the passenger's side of the automobile) which includes a set of day usage front window panels 32A and 34B and a set of night usage front window panels 32B and 34A. Furthermore, the set of rear window panels 44 (one located on the driver's side of the automobile and one located on the passenger's side of the automobile) include a set of day usage rear window panels 36A and 38B and a set of night usage rear window panels 36B and 38A. Additionally, in this embodiment, a rear window 40 is shown, wherein the rear window 40 (day vision) will depress to a back compartment and a night vision window will elevate to replace the day window. Additionally, in use, the set of day usage front window panels 32A and 34B and the set of day usage rear window panels 36A and 38B will depress to a front compartment and the night usage front window panels 32B and 34A and the set of night usage rear window panels 36B and 38A will elevate to replace the day window.

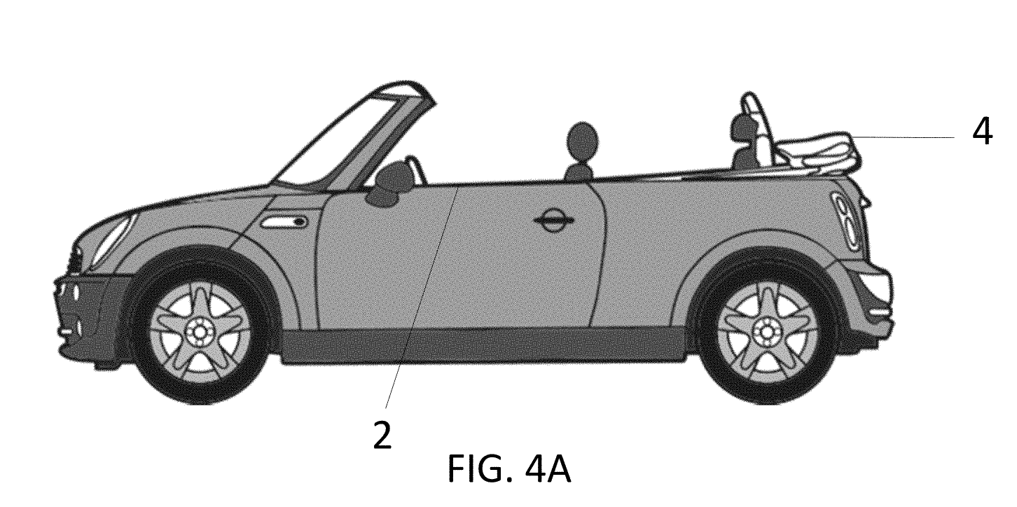

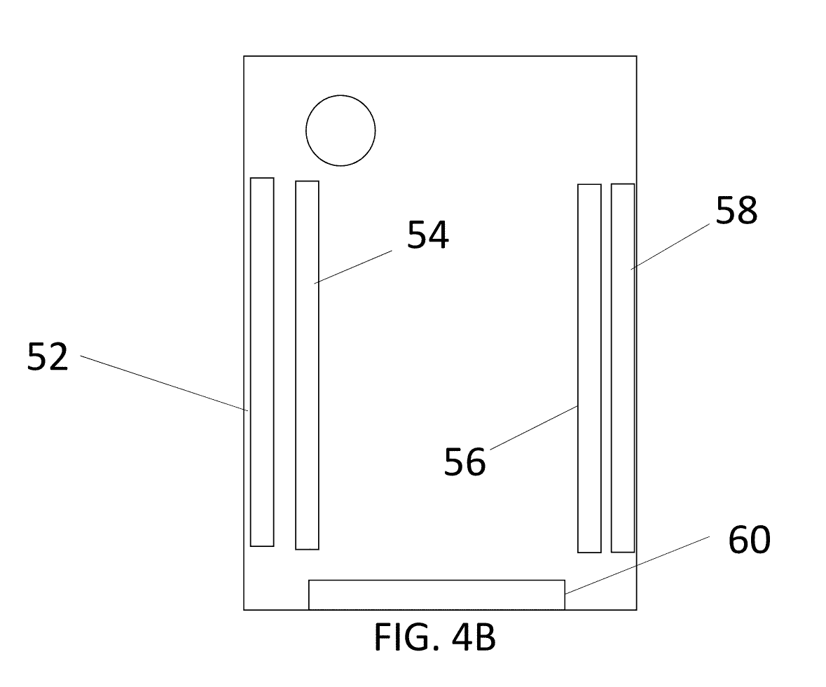

FIGS. 4A-4B illustrates a soft top convertible for use with the alternative vehicle vision system. In this embodiment, single or double window panels may be envisioned. Specifically for an embodiment with single window panels, a day window panel 52 and 58 (on the driver and passenger side of the vehicle respectively) would be built into the body of the automobile. Additionally, as shown in FIG. 4B, a night vision window 60 is made of a plastic material that folds and extends when the soft top 4 covers the car during the night. Also, in the embodiment with a single window panel, the day window and the night window may rotate the window glass into night and day vision coming from a single window panel. For the embodiment with double window panels, the proposed mechanism will be the same as described in FIG. 2.

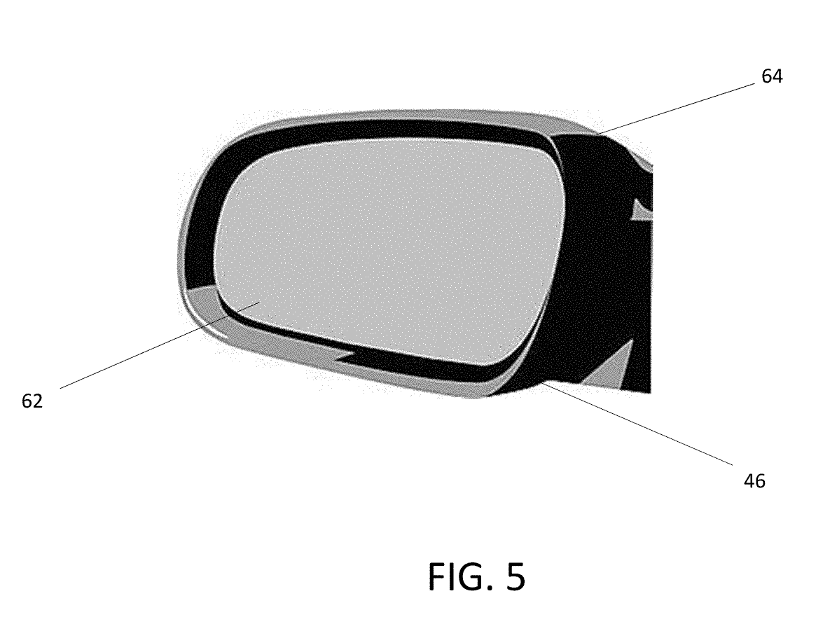

FIG. 5 illustrates a side view of a mirror 46 for a convertible automobile. This addendum to the proposed mechanism would allow each side mirror 44 to convert on both the right and left side 62 and 64 from day vision to night vision. This transformation would occur in the same manner when the windows described in earlier embodiments would transition from day usage to night usage.

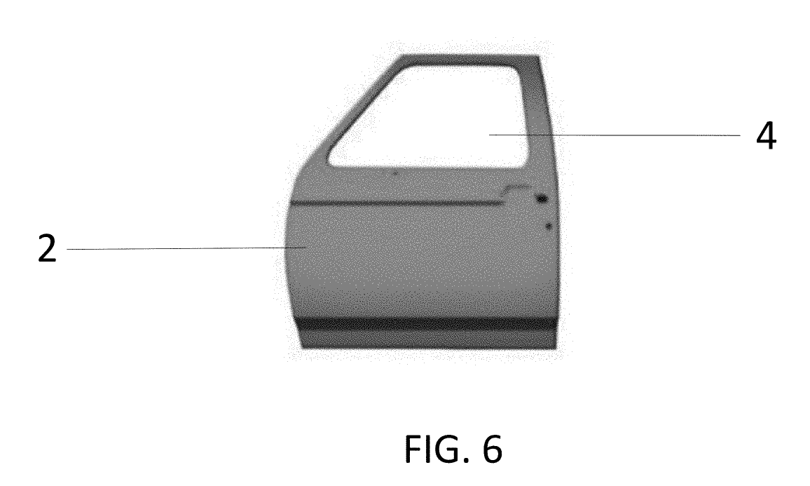

FIG. 6 illustrates another embodiment of the proposed alternate vehicle vision system. In this embodiment, as opposed to earlier embodiments, there will be only one window panel for day vision usage. This panel would use the latest technology of blending and mixing of low light imagery systems, thermal imaging and infrared illumination. With these technological advancements, the day vision would convert into night vision by activating a button for night vision, and vice versa. This button would be controlled by remote control. This infrared remote can operate TVs and videos in a short distance.

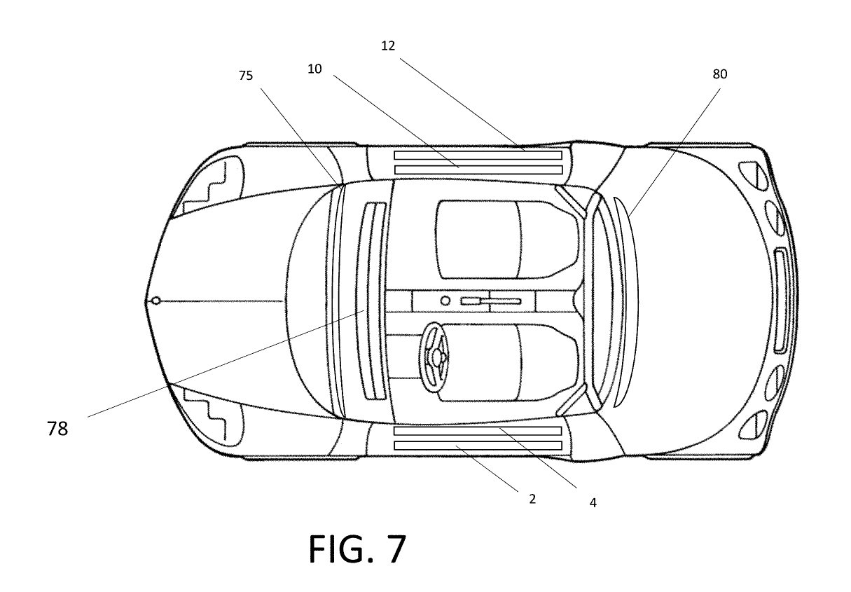

FIG. 7 illustrates another alternate embodiment of the vehicle vision system, wherein a front day vision window 75 will be permanent and an extendable/retractable night vision window 78 may be utilized. In an additional embodiment, the front day vision window will depress to a front compartment and the extendable/retractable night vision window 78 will elevate to replace the front day vision window 75. This may also be performed vice versa for both the front and rear window. Additionally, a retractable night vision rear window 80 which works independently of the soft or hard top may be utilized.

What is claimed is:

1. An alternative vehicle vision system wherein a driver can adjust window panels between day light and night light, the system comprising:
an automobile further comprising:
a set of front window panels comprising:
a set of day usage front window panels;
a set of night usage front window panels;
a set of rear window panels comprising:
a set of day usage rear window panels;
a set of night usage rear window panels; and
a rear window.

2. The alternative vehicle vision system of claim 1 wherein the set of day usage front window panels and the set of day usage rear window panels comprise a retractable construction and the set of night usage front window panels and the set of night usage rear window panels comprise a retractable construction.

3. The alternative vehicle vision system of claim 1, wherein the vehicle chassis comprises at least two door members wherein the set of front window panels usage is disposed within one of the at least two door members; and
wherein the set of rear window panels is disposed within the other of the at least two door members.

4. The alternative vehicle vision system of claim 2, wherein upon implementation of the alternative vehicle vision system, the set of day usage front window panels and the set of day usage rear window panels are retracted and the set of night usage front window panels and the set of night usage rear window panels is extended.

5. The alternative vehicle vision system of claim 1, wherein the window panels of a vehicle that is roofless during the day converts to night vision.

6. The alternative vehicle vision system of claim 1, wherein the vehicle has either single or double window panels.

7. The alternative vehicle vision system of claim 1, further comprising a soft top convertible comprising a set of window panels wherein the each individual in the set of window panels of the soft top convertible comprise a set of two window panels.

8. The alternative vehicle vision system of claim 6, wherein the at least one set of window panels for night usage is made of a polymeric material that folds and extends when the soft top covers the car during the night.

9. The alternative vehicle vision system of claim 1, wherein the at least one set of window panels for night usage uses a blending and mixing of low light imagery systems, thermal imaging and infrared illumination.

10. The alternative vehicle vision system of claim 1, wherein the day vision would convert to night vision by activating a button.

11. The alternative vehicle vision system of claim 1, further comprising:
a set of mirrors, wherein the set of mirrors converts between day usage and night usage.

12. The alternative vehicle vision system of claim 1, further comprising:
a front day vision window;
an extendable/retractable night vision window; and
a retractable night vision rear window.
